(19) United States
(12) Patent Application Publication
(10) Pub. No.: US 2010/0268672 A1
(43) Pub. Date: Oct. 21, 2010

(54) ACTION MANAGER FOR SYSTEM MANAGEMENT SYSTEMS

(75) Inventors: Thomas S. Brugler, Fuquay-Varina, NC (US); Todd M. Eischeid, Cary, NC (US); Mark E. Molander, Cary, NC (US); Kerry A. Ortega, Raleigh, NC (US)

Correspondence Address: Kenneth L. Sherman, Esq.;c/o MYERS ANDRAS SHERMAN LLP, 19900 MacArthur Blvd., Suite 1150, Irvine, CA, 92612, US

(73) Assignee: International Business Machines Corporation, Armonk, NY (US)

(21) Appl. No.: 12/427,543

(22) Filed: Apr. 21, 2009

(51) Int. Cl. G06F 17/00; G06F 15/18; G06F 17/30

(52) U.S. Cl. 706/11; 706/61; 707/E17.005

(57) ABSTRACT

An advisement manager is provided. One embodiment includes a processor connected to a memory device. A manager module executing on the processor, and is configured to receive an event signal triggered by an event, store content of the event signal in the memory device, retrieve information for responding to the event from different sources, and transmit the response information to an output device. An interface module is configured to display event information and the response information, and accept a response selection.

### BACKGROUND

1. Field of the Invention

The present invention relates generally to system management systems, and more in specifically, to an action manager to compliment system management systems.

2. Description of the Related Art

A central feature of many management systems is transmitting alerts upon occurrence of an event. The management systems notify a computer or human operator upon receiving an alert from a client system, device or service. For example, a management system may send a text message or signal to the operator, informing the operator that a device failure has occurred on a client server, e.g., a hard drive system. Frequently, the operator has to take some type of corrective action to resolve the error condition. The systems, however, only provide an alerting mechanism, and fails to provide any supporting tools/aids to assist the operator in resolving the problem.

### BRIEF SUMMARY

An advisement manager is provided according to an embodiment of the invention. One embodiment of the invention includes a processor connected to a memory device. A manager module executing on the processor, and is configured to receive an event signal triggered by an event, store content of the event signal in the memory device, retrieve information for responding to the event from different sources, and transmit the response information to an output device. An interface module is configured to display event information and the response information, and accept a response selection.

Another embodiment of the invention provides an advisement manager system. One embodiment of the invention includes event detection modules connected to system devices connected in a network. A processing device configured to receive detected event signals through the network and store event information in a memory device. An advisement manager module configured to retrieve event information from the memory device, and retrieve adaptable response information for responding to the event. A user interface configured to select event information and associated response information, receive response selection from the adaptable response information, and receive input for customized response information.

Still another embodiment of the invention provides a method for managing system events. One embodiment of the invention includes upon detecting a system event, transmitting a system event signal. A processor is used to associate event information with the system event signal and for storing the event information. Response information is received from many sources based on the event information. The event information and the response information are displayed on a user interface device. An action response selection is received from the user interface. The action response selection associated with the event information is stored.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates a block diagram of an advisement manager according to one embodiment of the invention;

FIG. 2 illustrates a block diagram of a system including an advisement manager according to one embodiment of the invention;

FIG. 3 illustrates a graphical user interface (GUI) including links to an advisement manager according to one embodiment of the invention;

FIG. 4 illustrates an example general GUI according to one embodiment of the invention;

FIG. 5 illustrates an example media GUI according to one embodiment of the invention;

FIG. 6 illustrates an example related topics GUI according to one embodiment of the invention;

FIG. 7 illustrates a block diagram of an action manager process according to one embodiment of the invention; and

FIG. 8 illustrates a centralized advisement manager for distributed systems according to an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc. The description may disclose several preferred embodiments for action managers for various system management systems, as well as operation and/or component parts thereof. While the following description will be described in terms of an action manager to compliment system management systems for clarity and placing the invention in context, it should be kept in mind that the teachings herein may have broad application to all types of systems, devices and applications.

An advisement manager configured to assist in responding to a system event is provided. In a preferred embodiment of the invention, a processor connected to a memory device. A manager module executes on the processor, and is configured to receive an event signal triggered by an event, store content of the event signal in the memory device, retrieve information for responding to the event from different sources, and transmit the response information to an output device. An interface module is configured to display event information and the response information, and accept a response selection.

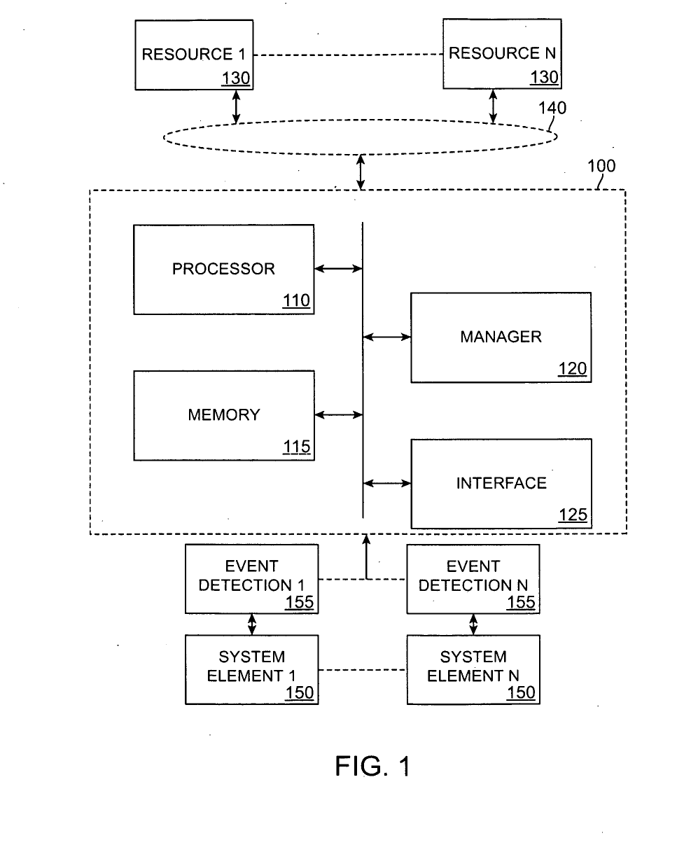

FIG. 1 illustrates a block diagram of an advisement manager 100 according to one embodiment of the invention. In one embodiment of the invention, advisement manager 100 includes a processor 110, a memory device 115, a manager module 120 and an interface 125. In some embodiments of the invention, processor 110 is a processing device, such as a central processing unit (CPU), integrated circuit, micro-circuit, etc. Memory device 115 may comprise multiple memory devices, including flash memory, cache memory, read-only memory (ROM), random access memory (RAM), virtual memory, etc. Interface 125 may comprise a display, a touch-screen, a keyboard, a pointing device, a voice recognition device, an optical sensor, etc., or any combination of the above.

In one embodiment of the invention, the manager module 120 may comprise a computer program product, a hardware device, a firmware device, etc., or any combination. In certain embodiments of the invention, the advisement manager 100 communicates over a network 140 to transmit and receive information. In these embodiments of the invention, the network 140 may be a wireless network, a wired network, multiple networks, or a combination of the above. The network 140 may comprise the Internet, a local area network (LAN), a wide area network (WAN), or any combination of the above.

In one embodiment of the invention, the advisement manager 100 may provide a number of tools/facets to resolve events generated by the system element 150, such as problems, warnings, errors, failures, etc. In this embodiment of the invention, system element 1 150 through system element N 150 (N being a positive integer) may include any system type element, such as hardware devices, cooling equipment, storage devices, detection devices, sensor devices, laboratory equipment, robotic equipment, nuclear facility equipment, system software components, television/radios station equipment, power systems/grids, telecommunication systems, network delivery equipment, factory systems, manufacturing systems, assembly system components, etc. The advisement manager 100 may include a variety of hardware/software tools for assisting in resolving system events, such as providing access to instant messaging, community support, audio-visual files, domain searches, documents, publication links, user defined entries/logs, etc.

In certain embodiments of the invention, the advisement manager 100 may store historical information including a state (current and past), event and response to events of system elements 150 through the various tools/aids. In this embodiment of the invention, the various tools/aids can display historical events and resolution or solution to the past events, which can possibly be used for current system event resolution/solution. In these embodiments of the invention, when an event occurs, the event and corresponding response are recorded. In one embodiment of the invention the recorded event information and corresponding response are associated and may be stored in a relational database. Then, the next time the event or a similar event occurs, any previously stored responses or solutions that are stored are available for access. In one embodiment of the invention, upon receipt of an event signal, a resource 1 130 through resource N 130 (N being a positive integer) are communicated with to obtain information associated with the event that has been identified. In one embodiment of the invention the resource information may be retrieved from internal or external locations and may include information retrieved from using event information (i.e., type of device or service, encountered problem, etc.) for searches of the Internet, Intranet, publication listings, manuals, databases, etc. based on an event type, search string including the identified event, etc. In this embodiment of the invention, the obtained information is stored in the memory device 115 for access in association with a response or solution with regard to the event.

In one embodiment of the invention, the previously stored responses may include newly added responses, customized responses, newly updated responses, legacy based responses, etc. In one embodiment of the invention, the stored responses are adapted over time to become more precisely related to new events based on history and heuristics. In one embodiment of the invention, the adaption relates to or using a problem-solving technique in which the most appropriate solution of several found solutions by alternative methods is selected at successive stages over time for use in the next solution or future solutions. In another embodiment of the invention, the adapted responses are presented based on probability of past success in correcting the event. In another embodiment of the invention, the stored responses are weighted and presented in a prioritized order based on past success of correcting the event.

In one embodiment of the invention, upon an event occurring through a system element 150, an event signal is triggered by event detection 1 155 through event detection N 155 (N being a positive integer) upon event detection 155 sensing or detecting the event. In one embodiment of the invention, event detection 1-N 155 may be a detector, a sensor, an event agent, an event module, etc. that is configured to transmit an event signal to the advisement manager 100. In this embodiment, the event signal is transmitted to the advisement manager 100 either wirelessly or through a wired network via event detection 155. The event signal may be a radio wave, transmission packet, program variable, socket, data, data stream, etc. In some embodiments of the invention each event is associated with a unique event identifier that is associated with likely event responses to correct or solve the event by the manager module 120. In one embodiment of the invention, responses and solutions to known possible events may be pre-entered into a memory device 115. For example, for a disk allocation error, audio-visual file(s) that demonstrate how to add storage, as well as specifying subject matter experts (i.e., contacts) may be presented through the interface 125 through a graphical user interface (GUI), browser, etc., on a display device, such as a monitor, personal digital assistant (PDA), portable computing device, ell phone, etc. In one embodiment of the invention, the memory device 115 may include a database including associated fields comprising: events, event identifiers, event responses, likelihood of success, past success, past failures, assistance files (e.g., audio/video, text, links, documents, etc.), etc.

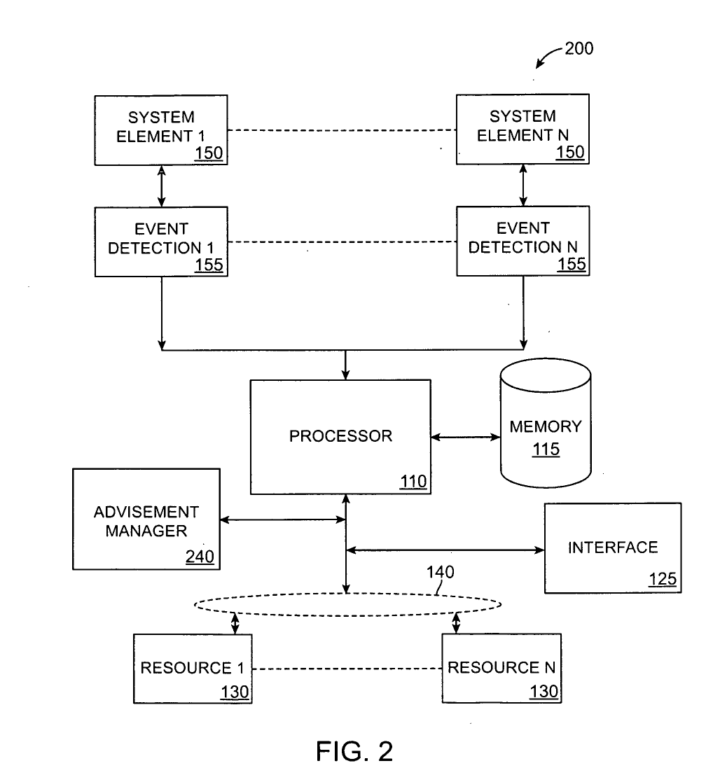

FIG. 2 illustrates a block diagram of a system 200 including an advisement manager 240 according to one embodiment of the invention. In one embodiment of the invention, system 200 includes system element 1 150 through system element N 150 (N being a positive integer), event detection 1 155 through event detection N 155, a processor 110, a memory device 115, an interface 125, a network 140 and an advisement manager module 240. In one embodiment of the invention, the advisement manager module 240 may comprise a standalone processor, a computer program product, a separate computer running one or more processes, etc. In another embodiment, the memory device 115 may comprise one or more large disk drives, virtual disks, etc.

In another embodiment of the invention, system 200 may include a large scale management system where advisement manager module 240 may be a centralized tool accessible throughout the system over multiple platforms, including workstations, kiosks, PDAs, remote computing devices/systems, hardwired terminals, etc. In this embodiment of the invention events detected in system 200 via event detection 155 may be viewed and retrieved responses or customized responses may be selected through the system 200 through any displays including graphical user interfaces (GUIs), browsers, screen shots, etc.

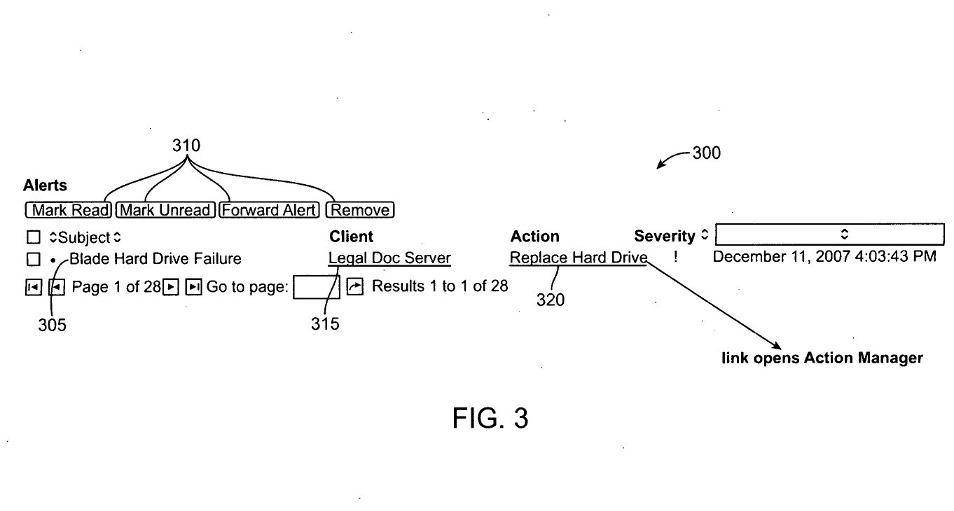

FIG. 3 illustrates an example of a GUI 300 including links to events displayed through advisement manager (e.g., advisement manager 100 in FIG. 1, or advisement manager 240 in FIG. 2), according to one embodiment of the invention. In one embodiment of the invention GUI 300 is an event log. In another embodiment of the invention, the GUI 300 may be a toolbar for a new or existing GUI or browser that may be displayed on an electronic display screen of a computing device. In this embodiment of the invention, the GUI 300 comprises a top level GUI for access for opening the advisement manager or other advisement management GUIs. In this example GUI 300, action buttons or tabs 310 represent actions to take for a corresponding listed event (e.g., event 305 indicating a Blade Hard Drive Failure). A link from a client 315, such as a computing device, a server device, etc., may include a link to a resource 130 (e.g., “Legal Doc. Server”). In one embodiment of the invention an action response link 320 may open other advisement manager GUIs for additional assistance in solving (or responding to) the event. Other alternative elements of GUI 300 may be displayed, such as time of the event, severity, etc.

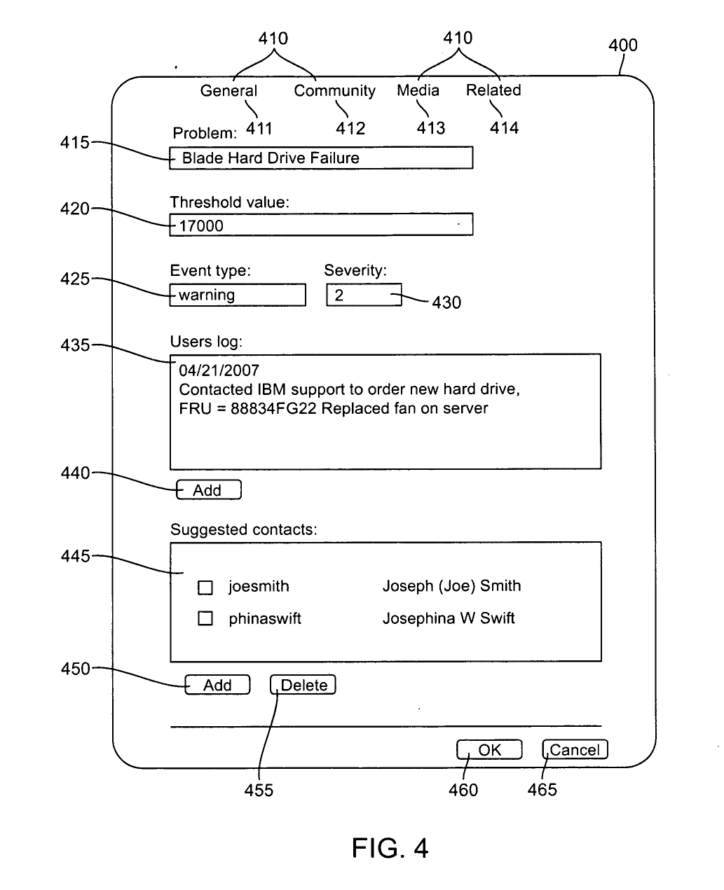

FIG. 4 illustrates an example GUI 400 showing a general display selected from selecting the link 305 from GUI 300 for the advisement manager (e.g., advisement manager 100 in FIG. 1, or advisement manager 240 in FIG. 2). In one embodiment of the invention the GUI 400 includes tabs 410 for selecting various different GUIs, also generated by the advisement manager (e.g., advisement manager 100 in FIG. 1, or advisement manager 240 in FIG. 2). In the example GUI 400, tabs 410 may include a General tab 411, a Community tab 412 (including community blogs, chats, questions/answers, articles, etc.), a Media tab 413, a Related topics/content tab 414, etc. for selecting different GUIs each generated by the advisement manager (e.g., advisement manager 100 in FIG. 1, or advisement manager 240 in FIG. 2). The example GUI 400 may include a problem display 415, a threshold value 420 (if appropriate for the event), event type 425, event severity 430, a user log 435, an add selection button 440 for the user log 435, suggested contacts 445, an add button 450 and a delete button 455 for the suggested contacts 445, an OK button 460 for accepting any modifications to GUI 400 and a cancel button 465 for canceling any modifications to the GUI 400. In one embodiment of the invention the general GUI 400 may include any basic information related to events and the system that the advisement manager is situated or used in, including distributed systems. In operation, GUI 400 operates as typical GUIs with the addition/deletion of information added through a device, such as a keyboard, selections made by devices, such as a pointing device, etc.

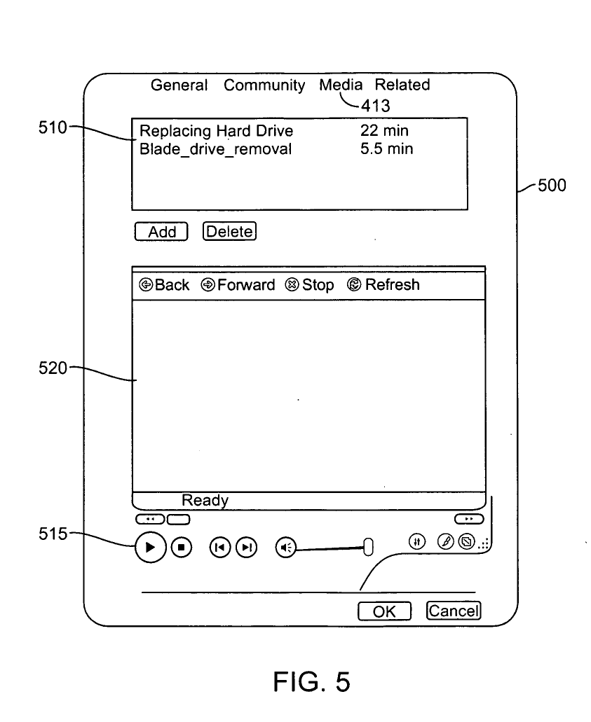

FIG. 5 illustrates an example GUI 500 showing an available media display selected from the media tab 413 on general GUI 400 for the advisement manager (e.g., advisement manager 100 in FIG. 1, or advisement manager 240 in FIG. 2). In one embodiment of the invention, GUI 500 may include all media 510 relating to the event; GUI 500 also generated by the advisement manager (e.g., advisement manager 100 in FIG. 1, or advisement manager 240 in FIG. 2). In one embodiment of the invention, the media 510 relating to the current event may be predetermined, associated over time based on resolved events, etc. In one embodiment of the invention the media 510 may be associated with the current type of event or category of event and associated with an event identification in a database. The media 510 may include media such as video(s), audio(s), video-audio, presentations, documentation, etc. The media may be displayed or viewed in area 520 on GUI 500 according to one embodiment of the invention. In other embodiments of the invention, the media 510 may be displayed in its own frame, GUI, page, etc. In one embodiment of the invention, controls 515 allow control of the media, such as play, stop, pause, fast forward, fast reverse, skip ahead, skip back, adjust sound level, GUI adjustments, etc.

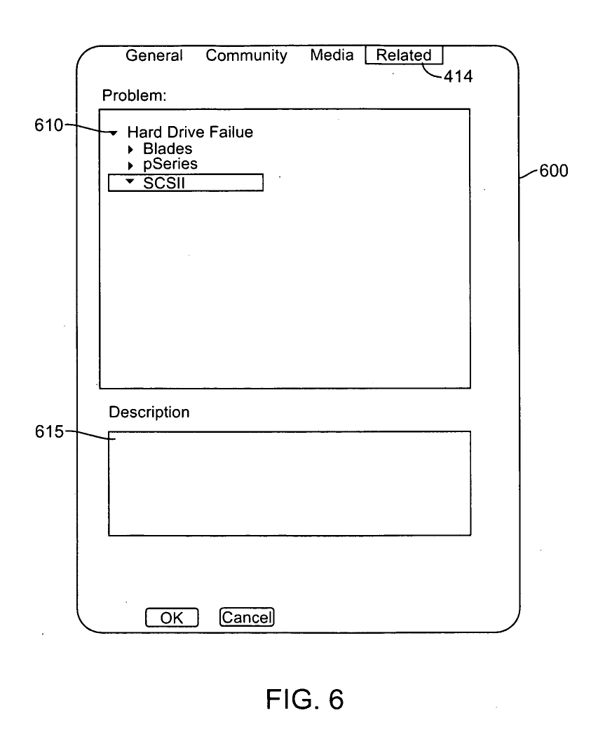

FIG. 6 illustrates an example GUI 600 showing related items 610 displayed through selection of the related tab 414 on GUI 400, such as topics, associated parts, systems, devices, etc. that are related to the event display for the advisement manager (e.g., advisement manager 100 in FIG. 1, or advisement manager 240 in FIG. 2). In one embodiment of the invention, based on the type of event, various related devices, services, associated possible problems, etc. (related elements) are categorized as related to the current system event. In one embodiment of the invention, these associated related elements are displayed based on predetermined possible problems/solutions, solututions from past events, etc. In this embodiment of the invention, the various related items 610 may be displayed and their particular descriptions may be displayed in area 615 of GUI 600. In one embodiment of the invention, different media associated with the related items 610 may also be displayed, played, listened to, etc.

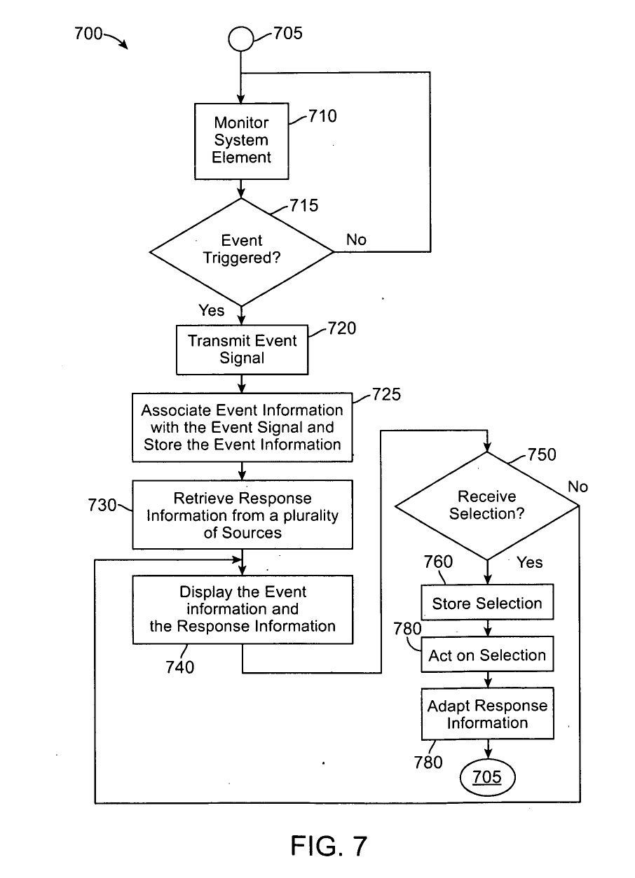

FIG. 7 illustrates a process 700 for providing advisement management to a managed system according to an embodiment of the invention. Process 700 begins at point 705. In block 710 system elements (e.g., system elements 150 shown in FIG. 1 and FIG. 2) are monitored for particular events. In block 715 it is determined if an event is triggered based on event detection by event detection 155. If an event is not triggered, process 700 returns to block 710 (i.e., continuous monitoring, monitoring intermittently, monitored at predetermined intervals, monitored based on scheduled maintenance interval, monitored based on expected life span, etc. by event detection 155). If an event is triggered, process 700 continues to block 720.

In block 720 an event signal is transmitted by an event detection 155 to an advisement manager (e.g., advisement manager 100 in FIG. 1, or advisement manager 240 in FIG. 2). In another embodiment of the invention, the event signal is transmitted to another device, such as a processor, a server, a client device, etc. Process 700 continues with block 725 where event information is associated with the event signal by processor 110 or the advisement manager (e.g., advisement manager 100 in FIG. 1, or advisement manager 240 in FIG. 2), and the event information is stored in a memory device 115 in FIG. 1 or FIG. 2. In one embodiment of the invention, the event information may be an event identification. In another embodiment of the invention, the event identification is further associated with other event information, such as predetermined response actions to the event, previously stored response actions for the event or similar events, etc. by the advisement manager (e.g., advisement manager 100 in FIG. 1, or advisement manager 240 in FIG. 2).

In block 730 response information is retrieved from a plurality of sources by the advisement manager (e.g., advisement manager 100 in FIG. 1, or advisement manager 240 in FIG. 2), such as internally stored information (e.g., documents, manuals, media, previously stored responses, etc.) and externally stored information (e.g., websites, systems, networks, manufacturers, vendors, etc.) according to one embodiment of the invention. In one embodiment of the invention, after all the response information is retrieved, the response information and the event information are presented in a display (e.g., interface 125 in FIG. 1 and FIG. 2) through a GUI, such as GUI 300 shown in FIG. 3, GUI 400 shown in FIG. 4, GUI 500 shown in FIG. 5, and GUI 600 shown in FIG. 6 in block 740, or a browser including one or more pages, a screen, a printout, etc. In one embodiment of the invention, the response and event information may be converted to words and sentences that are presented as audio so that the information may be received through a telephone system, a speaker, etc.

In block 750 it is determined if a selection of one or more responses to the event has been received though an interface, such as interface 125 shown in FIG. 1 and FIG. 2. If no selection has been made, process 700 continues back to block 740. If a selection has been made, and therefore received, process 700 continues to block 760. In block 760 the selection is stored for future use, statistics, heuristics, etc. in memory 115 shown in FIG. 1 and FIG. 2. In block 780 based on the selection, an action is taken to resolve the event, such as Replace Hard Drive as illustrated by action response link 320 in FIG. 3. In one embodiment of the invention, the action is the selected solution to the event. In block 780, future responses to the same or similar event are adapted based on the last selected action to improve the probability of resolving events using the adapted response information. In one embodiment of the invention by continuously adapting the response to events and similar events the presented response information continuously becomes more precise over time. This results in quicker solutions to system events and also improves learning for any system administrators or operators, whether human or robotic. After block 780, process 700 returns to point 705.

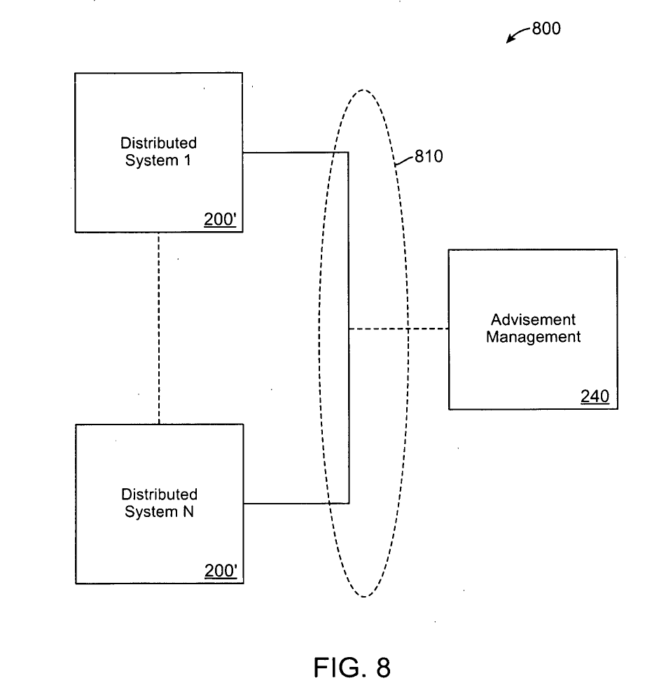

FIG. 8 illustrates a block diagram of example architecture of an embodiment of a system 800 including distributed system 1 200′ (i.e., system 200 without advisement manager 240 as part of system 200) through system N 200′ according to an embodiment of the invention. In this embodiment of the invention, the distributed systems 200′ are connected to a centralized advisement manager 240 through a network(s) 810, which can be wired, wireless, or any combination of wired and wireless networks. In this embodiment of the invention, the centralized advisement manager 240 may detect events and respond to the events with response information to the distributed systems 200′. In one embodiment of the invention the advisement manager 240 may be connected to another local system 200′. In another embodiment of the invention advisement manager 240 may receive event signals from the distributed systems 1 through N 200′. In some embodiments of the invention, advisement manager 240 may forward the event information to distributed systems 200′ to inform these systems of the event on another distributed system 200′ if the event in some way effects these distributed systems 200′.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart illustrated in FIG. 7 and block diagrams in FIGS. 1, 2 and 8 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters. In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An advisement manager apparatus, comprising:
a processor coupled to a memory device;
a manager module executing on the processor and configured to receive an event signal triggered by an event, store content of the event signal in the memory device, retrieve information for responding to the event from a plurality of sources, and transmit the response information to an output device; and
an interface module configured to display event information and the response information, and accept a response selection.

2. The advisement manager apparatus of claim 1, wherein the response selection is a customized response selection different from the transmitted response information.

3. The advisement manager apparatus of claim 2, wherein the response selection is stored for the particular event in a database.

4. The advertisement manager apparatus of claim 3, wherein the stored response selection is used as response information for similar categorized future events.

5. The advisement manager apparatus of claim 1, wherein the information for responding to the event is adapted over time based on previous response selections to improve a probability of solution response time to the event.

6. The advisement manager apparatus of claim 1, wherein the event signal includes an associated event identification.

7. An advisement manager system, comprising:
a plurality of event detection modules coupled to a plurality of system devices connected in a network;
a processing device configured to receive detected event signals through the network and store event information in a memory device;
an advisement manager module configured to retrieve event information from the memory device, and retrieve adaptable response information for responding to the event; and
a user interface configured to select event information and associated response information, receive response selection from the adaptable response information, and receive input for customized response information.

8. The advisement manager system of claim 7, wherein the response selection and the customized response information are stored for future adaptable response information associated with a similar categorized event.

9. The advisement manager system of claim 7, wherein the event signal includes an associated event identification.

10. A method for managing system events, the method comprising:
upon detecting a system event, transmitting a system event signal;
using a processor to associate event information with the system event signal and storing the event information;
retrieving response information from a plurality of sources based on the event information;
displaying the event information and the response information on a user interface device;
receiving an action response selection from the user interface; and
storing the action response selection associated with the event information.

11. The method of claim 10, wherein the response selection includes customized response information input through the user interface that is different from the retrieved response information.

12. The method of claim 11, wherein the response selection is stored for use as future response information for similar categorized events in a database.

13. The method of claim 10, wherein the event information includes one of text, audio and video.

14. The method of claim 10, further comprising:
adapting the response information for similar events over time based on selected action responses to improve a probability of solution response time to the event.

15. A computer program product for managing system events comprising a computer usable medium including a computer readable program, wherein the computer readable program when executed on a computer causes the computer to:
upon detection of a system event, transmit a system event signal;
associate event information with the system event signal and store the event information;
retrieve response information from a plurality of sources based on the event information;
display the event information and the response information on a user interface device;
receive an action response selection from the user interface; and
store the action response selection associated with the event information.

16. The computer program product of claim 15, wherein the response selection includes customized response information input through the user interface that is different from the retrieved response information.

17. The computer program product of claim 16, wherein the response selection is stored for use as future response information for similar categorized events in a database.

18. The computer program product of claim 15, wherein the event information includes one of text, audio and video.

19. The computer program product of claim 15, further causing the computer to:
adapt the response information for similar events over time based on selected action responses to improve a probability of solving the similar events.

20. The computer program product of claim 15, further causing the computer to:
associate system contact information with the event information; and
display the system contact information on the user interface device.
